(19) United States
(12) Patent Application Publication
(10) Pub. No.: US 2024/0013461 A1
(43) Pub. Date: Jan. 11, 2024

(54) Interactive Animation Generation

(71) Applicant: Shanghai Bilibili Technology Co., Ltd., Shanghai (CN)

(72) Inventors: Zhicong ZANG, Shanghai (CN); Kai ZHANG, Shanghai (CN); Shuqi QUAN, Shanghai (CN); Liangchao LU, Shanghai (CN)

(21) Appl. No.: 18/219,228

(22) Filed: Jul. 7, 2023

(30) Foreign Application Priority Data
Jul. 8, 2022 (CN) 202210806570.4

(51) Int. Cl. G06T 13/00

(52) U.S. Cl. CPC G06T 13/00; G06T 2210/28

(57) ABSTRACT

An interactive animation generation method is provided. The method includes: in response to receiving an instruction for viewing a comment by a first user, obtaining information about a comment section and information about an animation material based on the instruction; in response to receiving an interaction instruction of the first user for a second user in the comment section, obtaining first information of the first user and second information of the second user; and generating an interactive animation in the comment section based on the first information, the second information, and the information about the animation material.

### CROSS-REFERENCE TO RELATED APPLICATION

The present application claims priority to Chinese Patent Application No. 202210806570.4, filed with the China National Intellectual Property Administration on Jul. 8, 2022, which is incorporated herein by reference in its entirety.

### TECHNICAL FIELD

This application relates to the field of computer technologies, and in particular, to an interactive animation generation method, a computer device, and a storage medium.

### BACKGROUND

In a video comment interaction scenario, an interaction form between users affects enthusiasm of the users in participating in interaction, and further affects user traffic of a video platform. Therefore, a design of the interaction form in this scenario is extremely important.

### SUMMARY

According to an aspect of the embodiments of this application, a method is provided, including: in response to receiving an instruction for viewing a comment by a first user, obtaining information about a comment section and information about an animation material based on the instruction; in response to receiving an interaction instruction of the first user for a second user in the comment section, obtaining first information of the first user and second information of the second user; and generating an interactive animation in the comment section based on the first information, the second information, and the information about the animation material.

According to an aspect of the embodiments of this application, a computer device is further provided. The computer device includes one or more processors; and a memory, storing one or more programs configured to be executed by the one or more processors, the one or more programs including instructions for: in response to receiving an instruction for viewing a comment by a first user, obtaining information about a comment section and information about an animation material based on the instruction; in response to receiving an interaction instruction of the first user for a second user in the comment section, obtaining first information of the first user and second information of the second user; and generating an interactive animation in the comment section based on the first information, the second information, and the information about the animation material.

According to an aspect of the embodiments of this application, a non-transitory computer-readable storage medium is further provided. The non-transitory computer-readable storage medium stores one or more programs including instructions that, when executed by one or more processors of a computing device, cause the computing device to perform operations including: in response to receiving an instruction for viewing a comment by a first user, obtaining information about a comment section and information about an animation material based on the instruction; in response to receiving an interaction instruction of the first user for a second user in the comment section, obtaining first information of the first user and second information of the second user; and generating an interactive animation in the comment section based on the first information, the second information, and the information about the animation material.

### BRIEF DESCRIPTION OF DRAWINGS

FIG. 1 is a schematic diagram of an environmental architecture according to some embodiments of this application;

FIG. 2 is a schematic flowchart of an interactive animation generation method according to some embodiments of this application;

FIG. 3 is a diagram of an example of generating an interactive animation;

FIG. 4 is a schematic block diagram of an interactive animation generation apparatus according to some embodiments of this application;

FIG. 5 is a schematic flowchart of an animation material processing method according to some embodiments of this application;

FIG. 6 is a diagram of an example of a time sequence of an animation material processing scenario;

FIG. 7 is a schematic block diagram of an animation material processing apparatus according to some embodiments of this application; and

FIG. 8 is a schematic diagram of a hardware architecture of a computer device according to some embodiments of this application.

### DETAILED DESCRIPTION OF EMBODIMENTS

To make the objectives, technical solutions, and advantages of this application clearer and more comprehensible, the following further describes this application in detail with reference to the accompanying drawings and embodiments. It should be understood that the specific embodiments described herein are merely used to explain this application but are not intended to limit this application. All other embodiments obtained by a person of ordinary skill in the art based on the embodiments of this application without creative efforts shall fall within the protection scope of this application.

It should be noted that the descriptions such as “first” and “second” in the embodiments of this application are merely used for description, and shall not be understood as an indication or implication of relative importance or an implicit indication of a quantity of indicated technical features. Therefore, a feature limited by “first” or “second” may explicitly or implicitly include at least one feature. In addition, the technical solutions in the embodiments may be combined with each other, provided that a person of ordinary skill in the art can implement the combination. When the combination of the technical solutions is contradictory or cannot be implemented, it should be considered that the combination of the technical solutions does not exist and does not fall within the protection scope of this application.

In the descriptions of this application, it should be understood that numerical symbols before steps do not indicate a sequence of performing the steps, but are merely used to facilitate description of this application and differentiation of each step, and therefore cannot be construed as a limitation on this application.

The following explains terms of this application:

A graphics interchange format (GIF) is a bitmap graphic file format in which a true-color image is reproduced in 8-bit colors (that is, 256 colors). A set of a plurality of image decomposition actions forms a GIF animation.

A vector animation is an animation in which a mathematical equation is used in a computer to describe a complex curve on a screen, and an abstract motion feature of a graph is used to record changed picture information.

A sequence frame means that a dynamic video is represented by a plurality of frames of image files.

Queries per second (QPS) are a quantity of corresponding queries a server can perform per second.

A distributed cache is an extension of a conventional standalone cache concept, and is used to represent a cache that can span a plurality of servers while having scalability.

Redis is an open-source, network-enabled, in-memory, distributed, and, in some embodiments, persistent key-value pair storage database compiled by using ANSIC.

A server load balancer (SLB) is a load balancing service for performing traffic distribution on a plurality of cloud servers, and may extend a service capability of an application system to the outside world through traffic distribution, and improve availability of the application system by eliminating a single point of failure.

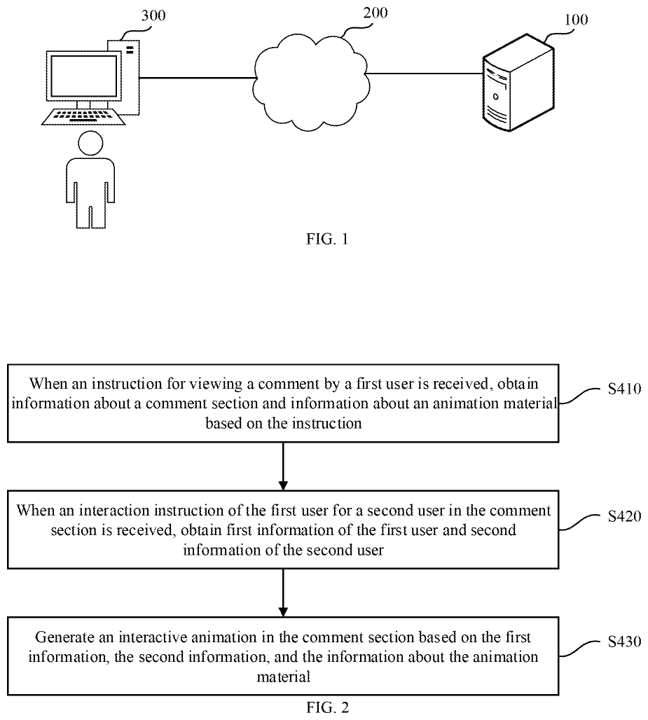

FIG. 1 is a schematic diagram of an environmental architecture according to some embodiments of this application.

As shown in FIG. 1, a client 300 is connected to a server 100 by using a network 200. When receiving an instruction for viewing a comment by a first user, the client 300 obtains information about a comment section and information about an animation material from the server 100 by using the network 200. When receiving an interaction instruction of the first user for a second user in the comment section in the current client, the client 300 obtains information about the first user and information about the second user, and generates an interactive animation in the comment section based on the information about the first user, the information about the second user, and the information about the animation material.

In example embodiments, the server 100 may refer to a data center, for example, a single house, or may be distributed in different geographic locations (for example, in several houses). The server 100 may provide a service by using one or more networks 200.

The network 200 includes various network devices, for example, a router, a switch, a multiplexer, a hub, a modem, a bridge, a repeater, a firewall, and/or a proxy device. The network 200 may include a physical link, for example, a coaxial cable link, a twisted-pair cable link, an optical fiber link, and/or a combination thereof. The network 200 may include a wireless link, for example, a cellular link, a satellite link, and/or a Wi-Fi link.

The client 300 may include, for example, a mobile device, a tablet device, a laptop computer, a smart device (for example, smart clothing, a smartwatch, or smart glasses), a virtual reality headset, a game device, a set-top box, a digital stream device, a robot, a vehicle-mounted terminal, a smart television, a TV box, or an ebook reader.

The inventor of the present application finds that in a related technology, an online platform has a single interaction form. For example, currently, the users in this scenario can interact with each other only by publishing comments, and the interaction form is single. Consequently, it is difficult to effectively improve enthusiasm of a user in participating in interaction.

According to interactive animation generation and animation material processing solutions in the embodiments of this application, interaction forms of an online platform can be enriched, and enthusiasm of a user in participating in interaction can be improved.

The interactive animation generation method and apparatus, the animation material processing method and apparatus, the computer device, and the storage medium that are provided in the embodiments of this application have the following advantages:

When the instruction for viewing the comment by the first user is received, the information about the comment section and the information about the animation material are obtained based on the instruction; when the interaction instruction of the first user for the second user in the comment section is received, the first information of the first user and the second information of the second user are obtained; and the interactive animation is generated in the comment section based on the first information, the second information, and the information about the animation material. Because the client can generate an interactive animation between users based on an interaction instruction of a user, interaction forms of an online platform can be enriched, thereby improving enthusiasm of the users in participating in interaction.

The following describes the interactive animation generation and animation material processing solutions in several embodiments.

FIG. 2 is a schematic flowchart of an interactive animation generation method according to some embodiments of this application. The method includes step S410 to step S430. For example, the client 300 in FIG. 1 is used as an execution body. Details are described below.

Step S410: When an instruction for viewing a comment by a first user is received, obtain information about a comment section and information about an animation material based on the instruction.

The first user may be a user operating the client 300.

When the comment section of a video page is expanded, the instruction for viewing a comment may be an instruction for opening the video page by the first user. When the comment section is collapsed, the instruction for viewing a comment may be an instruction for expanding the comment section by the first user through tapping. The instruction for viewing a comment may be specifically set based on an actual situation, and is not limited herein.

The animation material varies with the generated interactive animation, may be specifically determined based on a requirement of the generated interactive animation, and is not limited herein. For example, the generated interactive animation is making a toast, and the animation material may be a special-effect material of making a toast by two persons.

The information about the animation material may be specifically storage location information of the animation material in the server 100, so that the client 300 can obtain a corresponding animation material from the server 100 based on the information about the animation material.

Step S420: When an interaction instruction of the first user for a second user in the comment section is received, obtain first information of the first user and second information of the second user.

The interaction instruction may be obtained by the first user by double-tapping, long-pressing, or sliding a user avatar of the second user, may be specifically set based on an actual requirement, and is not specifically limited herein. For example, the first user double-taps the user avatar of the second user, and when detecting the double-tapping action, the client 300 considers that the interaction instruction is received.

The first information is information about the first user, and the second information is information about the second user. The first information and the second information may be specifically information such as IDs.

Step S430: Generate an interactive animation in the comment section based on the first information, the second information, and the information about the animation material.

In example embodiments, the information about the animation material includes storage location information of the animation material in the server 100. Step S430 may include: obtaining the animation material based on the storage location information; and generating the interactive animation in the comment section based on the first information, the second information, and the animation material.

That is, the client 300 obtains a corresponding animation material from the server 100 based on the storage location information, and then generates the interactive animation in the comment section on the client 300 based on the first information, the second information, and the animation material.

In some embodiments, the animation material is obtained based on the storage location information, and the interactive animation is generated in the comment section based on the first information, the second information, and the animation material. In this way, the client 300 can obtain the animation material required for generating the interactive animation, thereby facilitating generation of the interactive animation.

In example embodiments, the generating the interactive animation in the comment section based on the first information, the second information, and the animation material in the foregoing embodiments may include: obtaining a first avatar of the first user based on the first information, and obtaining a second avatar of the second user based on the second information; and generating the interactive animation in the comment section based on the first avatar, the second avatar, and the animation material.

The client 300 may obtain the first avatar of the first user from the server 100 based on the first information, obtain the second avatar of the second user from the server 100 based on the second information, and then generate the interactive animation in the comment section based on the first avatar, the second avatar, and the animation material. The first avatar is an avatar of the first user, and the second avatar is an avatar of the second user.

When the interactive animation is generated in the comment section, the interactive animation may be generated at a top layer of the comment section, and other content of the comment section is temporarily covered under the generated interactive animation.

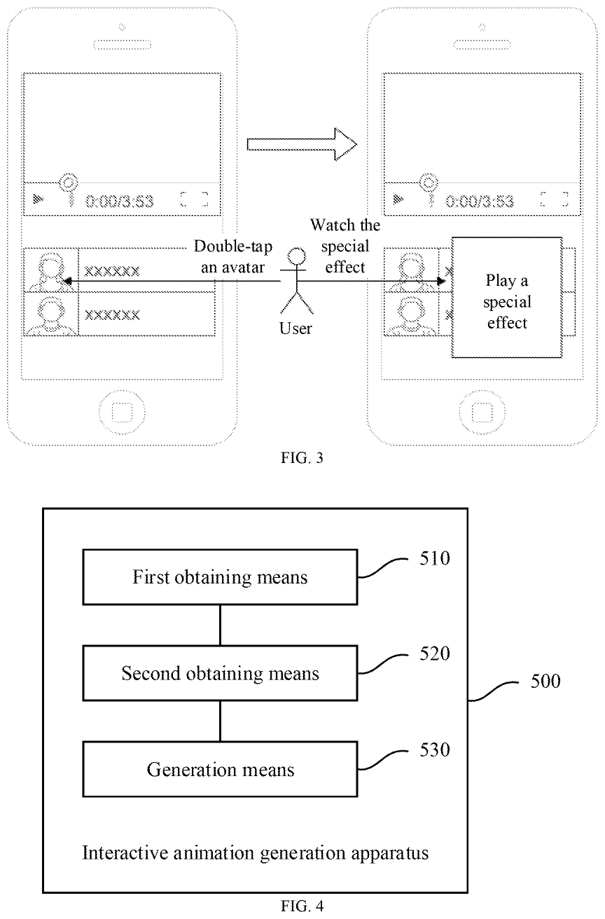

FIG. 3 is a diagram of an example of generating an interactive animation. As shown in the figure, the first user double-taps the avatar of the second user to send the interaction instruction. When receiving the interaction instruction, the client 300 generates the interactive animation in the comment section based on the interaction instruction. In this case, the user can see the generated interactive animation in the comment section.

In some embodiments, the first avatar of the first user is obtained based on the first information, the second avatar of the second user is obtained based on the second information, and the interactive animation is generated in the comment section based on the first avatar, the second avatar, and the animation material. Because different users have different first avatars, second avatars, and animation materials, generated interactive animations can have various different effects.

The client 300 may generate an animation in the form of a GIF animation, a vector animation, or the like when generating the interactive animation. However, the GIF animation or the vector animation generated by the client 300 may be not supported in some scenarios. In example embodiments, the generating the interactive animation in the comment section based on the first avatar, the second avatar, and the animation material in the foregoing embodiment s may further include: generating the interactive animation in the comment section in a sequence frame form based on the first avatar, the second avatar, and the animation material.

The animation in the sequence frame form is relatively common and has high rendering efficiency, which facilitates implementation of the interactive animation and export of the interactive animation. Therefore, generating the interactive animation in the sequence frame form may be applicable to more scenarios, and the generated animation is smoother. In addition, the user can also export the interactive animation for further sharing.

According to the interactive animation generation method in some embodiments of this application, when the instruction for viewing the comment by the first user is received, the information about the comment section and the information about the animation material are obtained based on the instruction; when the interaction instruction of the first user for the second user in the comment section is received, the first information of the first user and the second information of the second user are obtained; and the interactive animation is generated in the comment section based on the first information, the second information, and the information about the animation material. Because the client can generate an interactive animation between users based on an interaction instruction of a user, interaction forms of an online platform can be enriched, thereby improving enthusiasm of the users in participating in interaction.

In example embodiments, the obtaining information about a comment section and information about an animation material based on the instruction in step S410 may include: sending a content request to the server 100 based on the instruction, so that the server 100 obtains the information about the comment section and the information about the animation material based on the content request; and receiving the information about the comment section and the information about the animation material that are sent by the server.

In some embodiments, when obtaining the storage location information of the animation material in the server 100, the client 300 may send a specific request to the server 100 to obtain the storage location information of the animation material. The sending a content request to the server 100 based on the instruction to obtain the information about the comment section and the information about the animation material based on the content request means that the client 300 does not send a specific request to obtain the storage location information, but obtains the information about the animation material while obtaining the information about the comment section.

In some embodiments, the content request is sent to the server, so that the server returns the information about the animation material while returning the information about the corresponding comment section. Because the user corresponding to the client further interacts with another user only after obtaining content of the comment section, signaling overheads can be reduced by sending the content request to obtain the information about the comment section and the information about the animation material, thereby facilitating obtaining of the information about the animation material.

FIG. 4 is a schematic block diagram of an interactive animation generation apparatus 500 according to some embodiments of this application. The interactive animation generation apparatus 500 may be divided into one or more program means. The one or more program means are stored in a storage medium and executed by one or more processors, to complete some embodiments of this application. The program means in some embodiments of this application is a series of computer program instruction segments that can be used to complete a specific function. The following specifically describes a function of each program means in some embodiments.

As shown in FIG. 4, the interactive animation generation apparatus 500 may include a first obtaining means 510, a second obtaining means 520, and a generation means 530.

The first obtaining means 510 is configured to: when an instruction for viewing a comment by a first user is received, obtain information about a comment section and information about an animation material based on the instruction.

The second obtaining means 520 is configured to: when an interaction instruction of the first user for a second user in the comment section is received, obtain first information of the first user and second information of the second user.

The generation means 530 is configured to generate an interactive animation in the comment section based on the first information, the second information, and the information about the animation material.

In example embodiments, the information about the animation material includes storage location information of the animation material in a server. The generation means 530 is further configured to: obtain the animation material based on the storage location information; and generate the interactive animation in the comment section based on the first information, the second information, and the animation material.

In example embodiments, the generation means 530 is further configured to: obtain a first avatar of the first user based on the first information, and obtain a second avatar of the second user based on the second information; and generate the interactive animation in the comment section based on the first avatar, the second avatar, and the animation material.

In example embodiments, the first obtaining means 510 is further configured to: send a content request to the server based on the instruction, so that the server obtains the information about the comment section and the information about the animation material based on the content request; and receive the information about the comment section and the information about the animation material that are sent by the server.

In example embodiments, the generation means 530 is further configured to generate the interactive animation in the comment section in a sequence frame form based on the first avatar, the second avatar, and the animation material.

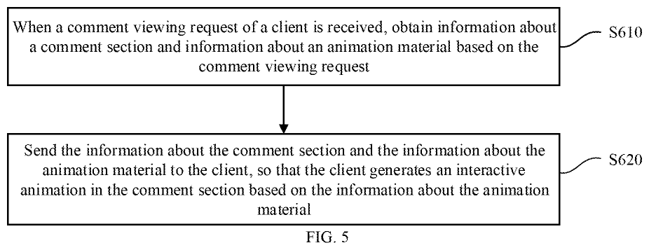

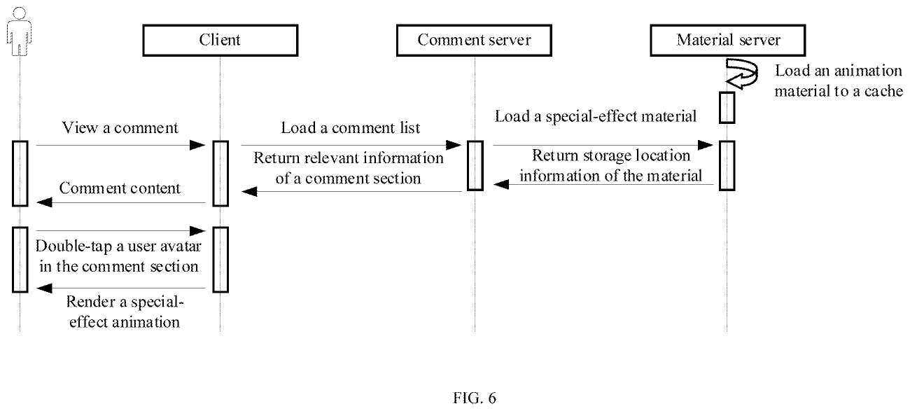

FIG. 5 is a schematic flowchart of an animation material processing method according to some embodiments of this application. The method includes step S610 and step S620. For example, the server 100 in FIG. 1 is an execution body. Details are described below.

Step S610: When a comment viewing request of a client is received, obtain information about a comment section and information about an animation material based on the comment viewing request.

In some embodiments, when the comment viewing request of the client 300 is received, the server 100 may perform authentication on the client 300, to determine whether the client 300 has a permission to obtain the information about the animation material. When the client 300 has the permission to obtain the information about the animation material, the client 300 obtains the information about the animation material. Otherwise, the client 300 returns corresponding prompt information (for example, “you have not been granted a corresponding animation permission”) or other information.

In some embodiments, animation materials corresponding to users are different. For example, the animation materials are classified into a plurality of categories, which respectively correspond to levels of the users. In this case, if the server 100 receives the comment viewing request of the client 300, the server 100 may first obtain an ID of a user corresponding to the client 300, and then obtain, based on the ID of the user, information about an animation material corresponding to the ID of the user.

In example embodiments, the animation material processing method may further include: regularly rendering and storing the animation material in a cache; and obtaining storage location information of the animation material in the cache, to obtain the information about the animation material.

Because the cache is regularly cleared, the animation material is regularly rendered and stored in the cache, so that the animation material can always be stored in the cache. When the animation material is regularly rendered and stored in the cache, a regular time may be set based on an actual situation, and is not limited herein, for example, is determined based on a time for cleaning the cache.

Because QPS of the comment section is high, if the animation material is stored in another manner other than the cache, the client has a large delay and poor experience when subsequently generating the interactive animation. Because a speed for reading the cache is high, regularly rendering and storing the animation material in the cache may improve efficiency of generating the interactive animation, reduce the delay, and improve user experience. Correspondingly, a response speed of an interaction platform with high QPS may be increased in a batch query form.

When the server 100 regularly renders and stores the animation material in the cache, the animation material may be stored in a distributed cache, for example, a distributed cache such as Redis. In example embodiments, the cache is a local cache of the server 100, that is, the server 100 renders and stores the animation material in the local cache.

Because a data volume of the animation material is not large, the animation material can be stored in the local cache. In addition, the local cache has a higher response speed than that of the distributed cache. Therefore, regularly storing the animation material in the local cache can improve efficiency of generating the interactive animation by the client 300 to a maximum extent.

In some embodiments, when generating the animation material, the server 100 may compress a size of the animation material while ensuring special-effect sharpness of the animation, so that the interactive animation is generated more quickly based on the animation material. The server 100 may further generate animation materials with different compression ratios, to meet requirements of different clients 300. For example, if the client 300 is correspondingly a tablet computer, because resolution of the tablet computer is large, the server 100 may return an animation material with a small compression ratio; or if the client 300 is correspondingly a mobile phone, because resolution of the mobile phone is small, the server 100 may return an animation material with a large compression ratio. In this way, the animation material obtained by the client 300 matches a condition of the client 300.

In some embodiments, the animation material may be regularly stored in the local cache of the server 100. When the local cache has insufficient space or is unavailable, the animation material is stored in the distributed cache. In other words, the local cache is preferentially used, and the distributed cache is secondly used, thereby ensuring high availability of the animation material. Further, loads of the local cache and the distributed cache may be balanced by using an SLB, so that the loads of the local cache and the distributed cache are balanced.

Step S620: Send the information about the comment section and the information about the animation material to the client, so that the client generates an interactive animation in the comment section based on the information about the animation material.

FIG. 6 is a diagram of an example of a time sequence of an animation material processing scenario. In the figure, the server 100 is divided into a comment server and a material server, and an approximate procedure of the animation material processing scenario is as follows:
1. The material server loads the animation material to the cache, that is, the material server renders an interactive special effect in advance and stores the interactive special effect in the cache.
2. A user views a comment, and the client sends a request to the comment server and the material server. The comment server and the material server return, based on the request, relevant information of the comment section (for example, comment content, a user ID, and a user avatar) and the storage location information of the animation material to the client.
3. A terminal corresponding to the client performs front-end rendering based on relevant content of the comment section, to generate a comment section below a video.
4. The user double-taps a user avatar of another user in the comment section. The terminal obtains the animation material based on the storage location information of the animation material, obtains the user avatar of the user on which double-tapping is performed and a user avatar of the current user, and renders and generates an interactive special effect (for example, a special effect of making a toast by two persons) for the user avatars of the current user and the user on which double-tapping is performed.

According to the animation material processing method in some embodiments of this application, when the comment viewing request of the client is received, the information about the comment section and the information about the animation material are obtained based on the comment viewing request, and the information about the comment section and the information about the animation material are sent to the client, so that the client obtains the animation material from the server based on the information about the animation material, and generates the interactive animation based on the animation material. Because the client can generate the interactive animation based on the animation material provided by the server, interaction forms of an online platform can be enriched, thereby improving enthusiasm of the user in participating in interaction.

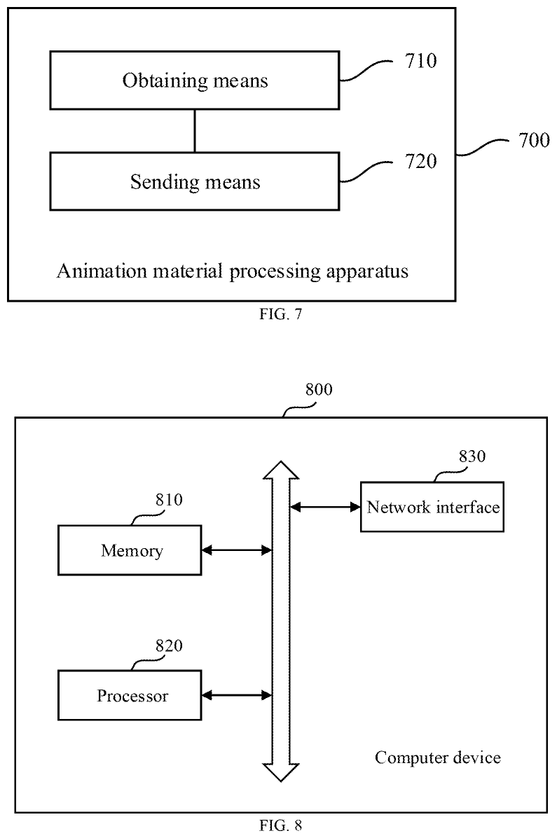

FIG. 7 is a schematic block diagram of an animation material processing apparatus 700 according to some embodiments of this application. The animation material processing apparatus 700 may be divided into one or more program means. The one or more program means are stored in a storage medium and executed by one or more processors, to complete some embodiments of this application. The program means in some embodiments of this application is a series of computer program instruction segments that can be used to complete a specific function. The following specifically describes a function of each program means in some embodiments.

As shown in FIG. 7, the animation material processing apparatus 700 may include an obtaining means 710 and a sending means 720.

The obtaining means 710 is configured to: when a comment viewing request of a client is received, obtain information about a comment section and information about an animation material based on the comment viewing request.

The sending means 720 is configured to send the information about the comment section and the information about the animation material to the client, so that the client generates an interactive animation in the comment section based on the information about the animation material.

In example embodiments, the animation material processing apparatus 700 further includes a storage means. The storage means is configured to: regularly render and store the animation material in a cache; and obtain storage location information of the animation material in the cache, to obtain the information about the animation material.

In example embodiments, the cache is a local cache of a server.

FIG. 8 is a schematic diagram of a hardware architecture of a computer device 800 applicable to an interactive animation generation method or an animation material processing method according to some embodiments of this application. The computer device 800 may be a device that can automatically calculate a value and/or process data based on instructions that are set or stored in advance. For example, the computer device 800 may be a rack server, a blade server, a tower server, a cabinet server (including an independent server, or a server cluster including a plurality of servers), a gateway, or the like. As shown in FIG. 8, the computer device 800 includes but is not limited to at least a memory 810, a processor 820, and a network interface 830 that can be communicatively connected to each other by using a system bus.

The memory 810 includes at least one type of computer-readable storage medium. The readable storage medium includes a flash memory, a hard disk, a multimedia card, a card-type memory (for example, an SD memory or a DX memory), a random access memory (RAM), a static random access memory (SRAM), a read-only memory (ROM), an electrically erasable programmable read-only memory (EEPROM), a programmable read-only memory (PROM), a magnetic memory, a magnetic disk, an optical disc, or the like. In some embodiments, the memory 810 may be an internal storage means of the computer device 800, for example, a hard disk or a memory of the computer device 800. In some other embodiments, the memory 810 may alternatively be an external storage device of the computer device 800, for example, a plug-in hard disk, a smart media card (SMC), a secure digital (SD) card, or a flash card (Flash card) that is disposed on the computer device 800. Certainly, the memory 810 may alternatively include both an internal storage means of the computer device 800 and an external storage device of the computer device 800. In some embodiments, the memory 810 is usually configured to store an operating system and various types of application software that are installed on the computer device 800, for example, program code of the interactive animation generation method or the animation material processing method. In addition, the memory 810 may be further configured to temporarily store various types of data that have been output or are to be output.

The processor 820 may be a central processing unit (CPU), a controller, a microcontroller, a microprocessor, or another data processing chip in some embodiments. The processor 820 is usually configured to control an overall operation of the computer device 800, for example, perform control and processing related to data exchange or communication performed by the computer device 800. In some embodiments, the processor 820 is configured to run program code stored in the memory 810 or process data.

The network interface 830 may include a wireless network interface or a wired network interface, and the network interface 830 is usually configured to establish a communication link between the computer device 800 and another computer device. For example, the network interface 830 is configured to connect the computer device 800 to an external terminal by using a network, and establish a data transmission channel, a communication link, and the like between the computer device 800 and the external terminal. The network may be a wireless or wired network, for example, an Intranet, the Internet, a global system of mobile communication (GSM), wideband code division multiple access (WCDMA), a 4G network, a 5G network, Bluetooth, or Wi-Fi.

It should be noted that FIG. 8 shows only a computer device that has the component 810 to the component 830. However, it should be understood that implementation of all the shown components is not required, and more or fewer components may alternatively be implemented.

In some embodiments, the interactive animation generation method or the animation material processing method stored in the memory 810 may be further divided into one or more program means, and executed by one or more processors (the processor 820 in some embodiments), to complete some embodiments of this application.

Some embodiments of this application further provides a computer-readable storage medium. The computer-readable storage medium stores a computer program. When the computer program is executed by a processor, the steps of the interactive animation generation method or the animation material processing method in the embodiments are implemented.

In some embodiments, the computer-readable storage medium includes a flash memory, a hard disk, a multimedia card, a card-type memory (for example, an SD memory or a DX memory), a random access memory (RAM), a static random access memory (SRAM), a read-only memory (ROM), an electrically erasable programmable read-only memory (EEPROM), a programmable read-only memory (PROM), a magnetic memory, a magnetic disk, an optical disc, or the like. In some embodiments, the computer-readable storage medium may be an internal storage unit of a computer device, for example, a hard disk or a memory of the computer device. In some other embodiments, the computer-readable storage medium may alternatively be an external storage device of the computer device, for example, a plug-in hard disk, a smart media card (SMC), a secure digital (SD) card, or a flash card that is disposed on the computer device. Certainly, the computer-readable storage medium may alternatively include both an internal storage unit of the computer device and an external storage device of the computer device. In some embodiments, the computer-readable storage medium is usually configured to store an operating system and various types of application software that are installed on the computer device, for example, program code of the interactive animation generation method or the animation material processing method in the embodiments. In addition, the computer-readable storage medium may be further configured to temporarily store various types of data that have been output or are to be output.

Clearly, a person skilled in the art should understand that the foregoing means or steps in the embodiments of this application may be implemented by using a general computing apparatus. The means or steps may be integrated into a single computing apparatus or distributed in a network including a plurality of computing apparatuses. In some embodiments, the means or steps may be implemented by using program code that can be executed by the computing apparatus. Therefore, the means or steps may be stored in a storage apparatus for execution by the computing apparatus. In addition, in some cases, the shown or described steps may be performed in a sequence different from the sequence herein. Alternatively, the means or steps may be separately made into integrated circuit means, or a plurality of means or steps in the means or steps are made into a single integrated circuit means for implementation. In this way, a combination of any specific hardware and software is not limited in the embodiments of this application.

The foregoing descriptions are merely preferred embodiments of this application, and are not intended to limit the scope of this application. Any equivalent structure or equivalent procedure change made based on the content of this specification and the accompanying drawings of this application is directly or indirectly applied to other related technical fields, and shall fall within the protection scope of this application.

What is claimed is:

1. A method, comprising:
in response to receiving an instruction for viewing a comment by a first user, obtaining information about a comment section and information about an animation material based on the instruction;
in response to receiving an interaction instruction of the first user for a second user in the comment section, obtaining first information of the first user and second information of the second user; and
generating an interactive animation in the comment section based on the first information, the second information, and the information about the animation material.

2. The method according to claim 1, wherein the information about the animation material comprises storage location information of the animation material in a server; and
the generating the interactive animation in the comment section based on the first information, the second information, and the information about the animation material comprises:
obtaining the animation material based on the storage location information; and
generating the interactive animation in the comment section based on the first information, the second information, and the animation material.

3. The method according to claim 2, wherein the generating the interactive animation in the comment section based on the first information, the second information, and the animation material comprises:
obtaining a first avatar of the first user based on the first information, and obtaining a second avatar of the second user based on the second information; and
generating the interactive animation in the comment section based on the first avatar, the second avatar, and the animation material.

4. The method according to claim 3, wherein the obtaining the information about the comment section and the information about the animation material based on the instruction comprises:
sending a content request to the server based on the instruction, so that the server obtains the information about the comment section and the information about the animation material based on the content request; and
receiving the information about the comment section and the information about the animation material that are sent by the server.

5. The method according to claim 3, wherein the generating the interactive animation in the comment section based on the first avatar, the second avatar, and the animation material comprises:
generating the interactive animation in the comment section in a sequence frame form based on the first avatar, the second avatar, and the animation material.

6. The method according to claim 1, wherein the information about the comment section and the information about the animation material is obtained from a server by sending a comment viewing request to the server.

7. The method according to claim 6, wherein the animation material is regularly rendered and stored in a cache by the server; and
wherein the information about the animation material is obtained based on storage location information of the animation material in the cache.

8. The method according to claim 7, wherein the cache is a local cache of the server.

9. A computer device, comprising:
one or more processors; and
a memory, storing one or more programs configured to be executed by the one or more processors, the one or more programs comprising instructions for:
in response to receiving an instruction for viewing a comment by a first user, obtaining information about a comment section and information about an animation material based on the instruction;
in response to receiving an interaction instruction of the first user for a second user in the comment section, obtaining first information of the first user and second information of the second user; and
generating an interactive animation in the comment section based on the first information, the second information, and the information about the animation material.

10. The computer device according to claim 9, wherein the information about the animation material comprises storage location information of the animation material in a server; and
the generating the interactive animation in the comment section based on the first information, the second information, and the information about the animation material comprises:
obtaining the animation material based on the storage location information; and
generating the interactive animation in the comment section based on the first information, the second information, and the animation material.

11. The computer device according to claim 10, wherein the generating the interactive animation in the comment section based on the first information, the second information, and the animation material comprises:
obtaining a first avatar of the first user based on the first information, and obtaining a second avatar of the second user based on the second information; and
generating the interactive animation in the comment section based on the first avatar, the second avatar, and the animation material.

12. The computer device according to claim 11, wherein the obtaining the information about the comment section and the information about the animation material based on the instruction comprises:
sending a content request to the server based on the instruction, so that the server obtains the information about the comment section and the information about the animation material based on the content request; and
receiving the information about the comment section and the information about the animation material that are sent by the server.

13. The computer device according to claim 11, wherein the generating the interactive animation in the comment section based on the first avatar, the second avatar, and the animation material comprises:
generating the interactive animation in the comment section in a sequence frame form based on the first avatar, the second avatar, and the animation material.

14. The computer device according to claim 9, wherein the information about the comment section and the information about the animation material is obtained from a server by sending a comment viewing request to the server.

15. The computer device according to claim 14, wherein the animation material is regularly rendered and stored in a cache by the server; and
wherein the information about the animation material is obtained based on storage location information of the animation material in the cache.

16. A non-transitory computer-readable storage medium, wherein the non-transitory computer-readable storage medium stores one or more programs comprising instructions that, when executed by one or more processors of a computing device, cause the computing device to perform operations comprising:
in response to receiving an instruction for viewing a comment by a first user, obtaining information about a comment section and information about an animation material based on the instruction;
in response to receiving an interaction instruction of the first user for a second user in the comment section, obtaining first information of the first user and second information of the second user; and
generating an interactive animation in the comment section based on the first information, the second information and the information about the animation material.

17. The non-transitory computer-readable storage medium according to claim 16, wherein the information about the animation material comprises storage location information of the animation material in a server; and
the generating the interactive animation in the comment section based on the first information, the second information, and the information about the animation material comprises:
obtaining the animation material based on the storage location information; and
generating the interactive animation in the comment section based on the first information, the second information, and the animation material.

18. The non-transitory computer-readable storage medium according to claim 17, wherein the generating the interactive animation in the comment section based on the first information, the second information, and the animation material comprises:
obtaining a first avatar of the first user based on the first information, and obtaining a second avatar of the second user based on the second information; and
generating the interactive animation in the comment section based on the first avatar, the second avatar, and the animation material.

19. The non-transitory computer-readable storage medium according to claim 18, wherein the obtaining the information about the comment section and the information about the animation material based on the instruction comprises:
sending a content request to the server based on the instruction, so that the server obtains the information about the comment section and the information about the animation material based on the content request; and
receiving the information about the comment section and the information about the animation material that are sent by the server.

20. The non-transitory computer-readable storage medium according to claim 18, wherein the generating the interactive animation in the comment section based on the first avatar, the second avatar, and the animation material comprises:
generating the interactive animation in the comment section in a sequence frame form based on the first avatar, the second avatar, and the animation material.
